(19) United States
(12) Patent Application Publication
(10) Pub. No.: US 2026/0084934 A1
(43) Pub. Date: Mar. 26, 2026

(54) ELEVATOR MACHINE SUPPORT STRUCTURE AND ELEVATOR SYSTEM COMPRISING AN ELEVATOR MACHINE SUPPORT STRUCTURE

(71) Applicant: Otis Elevator Company, Farmington, CT (US)

(72) Inventor: Lucia Fito, Leganes, Madrid (ES)

(21) Appl. No.: 19/339,955

(22) Filed: Sep. 25, 2025

(30) Foreign Application Priority Data
Sep. 26, 2024 (EP) 24383034.6

(51) Int. Cl. B66B 11/00; B66B 7/08; B66B 9/00

(52) U.S. Cl. CPC B66B 11/0045; B66B 7/08; B66B 9/00; B66B 11/008

(57) ABSTRACT

An elevator machine support structure (30) comprises a machine bedplate (32) for supporting an elevator machine (5) on a first side of the machine bedplate (32); and a tension member dead end hitch (36) that is configured for mechanically coupling with an end of at least one elevator tension member (3). The tension member dead end hitch (36) extends from a second side of the machine bedplate (32) opposite to the first side.

### FOREIGN PRIORITY

This application claims priority to European Patent Application No. 24383034.6, filed Sep. 26, 2024, and all the benefits accruing therefrom under 35 U.S.C. § 119, the contents of which in its entirety are herein incorporated by reference.

### TECHNICAL FIELD OF INVENTION

The invention relates to an elevator machine support structure for supporting an elevator machine of an elevator system. The invention further relates to an elevator system comprising such an elevator machine support structure.

### BACKGROUND OF THE INVENTION

An elevator system comprises at least one elevator car that is configured for moving along a hoistway extending between a plurality of landings and an elevator machine for driving the at least one elevator car. The elevator system further comprises at least one tension member for suspending the at least one elevator car and for mechanically coupling the at least one elevator car with the elevator machine.

In case a 2:1 roping or a similar roping is employed for suspending the elevator car, opposite ends of the at least one tension member need to be fixed to a stationary structure within the hoistway.

It would be beneficial to provide a space saving structure that allows for fixing the opposite ends of the at least one tension member within the hoistway.

### SUMMARY OF THE INVENTION

Exemplary embodiments of the invention include an elevator machine support structure comprising a machine bedplate for supporting an elevator machine on a first side of the machine bedplate. The elevator machine support structure further comprises a tension member dead end hitch that is configured for mechanically coupling with an end of at least one elevator tension member. The tension member dead end hitch extends from a second side of the machine bedplate opposite to the first side supporting the elevator machine. When the elevator machine support structure is installed in the hoistway of an elevator system, the first side of the machine bedplate faces upwards towards the top of the hoistway and the second side faces downwards towards the bottom of the hoistway.

Exemplary embodiments of the invention further include an elevator system comprising a hoistway extending between a plurality of landings; an elevator car that is movable within the hoistway between the plurality of landings; an elevator machine support structure according to an exemplary embodiment of the invention, which is located in the hoistway; an elevator machine for moving the elevator car within the hoistway; and at least one elevator tension member mechanically coupling the elevator car with the elevator machine for allowing the elevator machine to move the elevator car within the hoistway. The elevator machine is supported on a first side of the machine bedplate of the elevator machine support structure. An end of the at least one elevator tension member is coupled to the tension member dead end hitch that extends from an opposite second side of the machine bedplate.

When an elevator machine support structure according to an exemplary embodiment of the invention is employed in an elevator system, an end of the at least one tension member may be fixed to the elevator machine support structure in a position below the elevator machine, in particular in a position that is not offset from the position of the elevator machine in a lateral direction, i.e. in a direction that is oriented transversely to the longitudinal direction of the hoistway.

An elevator machine support structure according to an exemplary embodiment of the invention allows for arranging the first tension member dead end hitch in a space saving configuration below the elevator machine. This allows for maximizing the size of the elevator car and/or for minimizing the space needed for the hoistway.

When an elevator machine support structure according to an exemplary embodiment of the invention is employed, the elevator machine may be arranged on the bedplate in a position in which it does not interfere with the elevator car guide members. The elevator machine may in particular be positioned on the bedplate in a configuration in which no cutouts need to be formed in the elevator car guide member.

In addition, the horizontal distance between the tension member(s) and the elevator car guide members may be reduced. This allows for reducing noise and vibrations generated by operating the elevator system. As a result, the riding experience of passengers using the elevator system may be improved.

In the following, a number of optional features of an elevator system according to exemplary embodiments of the invention are set out. These features may be realized in particular embodiments, alone or in combination with any of the other features, unless explicitly stated otherwise.

The machine bedplate may comprise an upper horizontal wall and a lower horizontal wall. The upper horizontal wall may be configured for supporting the elevator machine on an upper side thereof. The tension member dead end hitch may be mounted to the lower horizontal wall such as to extend from a lower side of the lower horizontal wall. The machine bedplate may further comprise vertical side walls extending between the upper and lower horizontal walls. The horizontal and vertical walls may in particular form a rigid rectangular profile for supporting the elevator machine and the tension member dead end hitch.

The tension member dead end hitch may comprise two legs extending downwards from the lower second side of the machine bedplate. The two legs may extend basically parallel to each other perpendicularly to the machine bedplate. The tension member dead end hitch may further comprise a hitch portion extending between the two legs. The hitch portion may be arranged in a distance from the lower second side of the machine bedplate. The hitch portion may extend horizontally between the two legs, parallel to the machine bedplate. A tension member dead end hitch having such a configuration allows for fixing the end of the at least one tension member of the elevator system in a space saving configuration below the elevator machine.

Each of the two legs may comprise an upper portion that extends parallel to the machine bedplate and that may be fixed to the machine bedplate.

Each of the two legs may further comprise a lower portion extending basically parallel to the machine bedplate. The lower portions of the two legs of the tension member dead end hitch may be mechanically coupled with each other.

The lower portions of the two legs may be welded to each other and/or the lower portions of the two legs may be coupled with each other by fixing elements, such as bolts or screws. In an alternative configuration, the two legs may be formed integrally with each other.

The hitch portion may comprise a profile having a generally rectangular cross section providing a mechanically stable and rigid hitch portion.

The tension member dead end hitch may comprise at least one tension member termination device including a tension member fixing device, for example at least one wedge clamp that is configured for securely coupling with an end of at least one tension member.

The at least one tension member termination device may be configured for releasably coupling with an end of the at least one tension member in order to allow for conveniently replacing the at least one tension member.

The tension member termination device may be supported by the tension member dead end hitch, particularly by the hitch portion of the tension member dead end hitch, in a suspending manner.

The at least one elevator tension member may be coupled to the tension member dead end hitch via a spring mechanism that allows for an elastic movement of the at least one elevator tension member with respect to the tension member dead end hitch. The spring mechanism may be coupled between the tension member termination device and the hitch portion of the tension member dead end hitch. The spring mechanism may in particular be arranged in a space that is formed between the hitch portion and the lower wall of the machine bedplate.

The walls of the machine bedplate, the legs and the hitch portion of the elevator machine support structure may be made of a sheet material, in particular of sheet metal, such as steel. Forming the machine bedplate, the legs and the hitch portion of the elevator machine support structure of a sheet material allows for providing a mechanically stable and rigid elevator machine support structure at low costs.

The elevator machine support structure may comprise fixing elements, such as bolts or screws, for fixing the two legs to the machine bedplate and/or for fixing the hitch portion to the two legs. Alternatively or additionally, the two legs may be welded to the machine bedplate and/or the hitch portion may be welded to the two legs. In a further embodiment, the hitch portion and the two legs may be formed integrally with each other.

The hitch portion may be configured for mechanically coupling with a plurality of tension member termination devices associated with the ends of a plurality of elevator tension members. This allows for employing a plurality of elevator tension members in the elevator system.

The at least one elevator tension member may be a belt. Providing the elevator tension member in the form of a belt allows for reducing the diameter of a traction sheave that is employed for driving the elevator tension member. It also allows for reducing the diameter of pulleys used for deflecting the at least one elevator tension member.

The belt may comprise one or more steal cores and a coating made of a synthetic material. The one or more steal cores may be embedded in the synthetic material.

As a result, the dimensions of the elevator machine may be reduced so that the elevator machine may be installed within the hoistway without increasing the dimensions of the hoistway. In consequence, the overall dimensions of the elevator system, in particular the height of the elevator system, may be reduced as well.

In an elevator system according to an exemplary embodiment of the invention, the at least one elevator tension member may be coupled to the tension member dead end hitch by a tension member termination device including a tension member fixing device, such as a wedge clamp. This allows for coupling the at least one elevator tension member reliably and releasably to the tension member dead end hitch.

An elevator system according to an exemplary embodiment of the invention may comprise a counterweight coupled to the at least one elevator tension member for moving concurrently and in opposite direction with respect to the elevator car. Adding a counterweight to the elevator system may allow for reducing the torque that needs to be provided by the elevator machine for moving the elevator car.

An elevator system according to an exemplary embodiment of the invention may comprise a plurality of elevator tension members extending parallel to each other. Employing a plurality of elevator tension members allows for distributing the load of the elevator car and of the counterweight over a plurality of elevator tension members. This provides additional safety due to redundancy. It also allows for reducing the dimensions of each of the plurality of elevator tension members compared to a configuration in which only a single elevator tension member is employed.

The counterweight may be equipped with at least one counterweight pulley for mechanically coupling the counterweight to the at least one elevator tension member. This allows for employing a 2:1 roping in the elevator system.

The elevator car and the counterweight may be coupled to the elevator machine by the at least one elevator tension member employing a 2:1 roping. Employing a 2:1 roping allows for efficiently increasing the force acting on the elevator car and reducing the speed of the elevator car at low costs. This allows for employing a relatively small fast rotating motor in the elevator machine without adding a reduction gear for reducing the rotational speed of the motor. As a result, the costs of the elevator machine may be reduced.

The elevator car may in particular be coupled to the elevator machine by an underslung 2:1 roping, in which a portion of the at least one elevator tension member extends across the bottom of the elevator car between elevator car pulleys mounted to the bottom of the elevator car. An underslung 2:1 roping allows for reducing the space that is needed within the hoistway above the elevator car when the elevator car is located in its uppermost position. In consequence, the length of the hoistway may be used more efficiently when an underslung 2:1 roping is employed.

Exemplary embodiments of the invention may also include elevator systems with ropings that further enhance the forces applied to the elevator car while achieving an even greater reduction in its speed, such as 4:1 ropings. Optionally, these ropings may be underslung ropings as well.

### BRIEF DESCRIPTION OF THE DRAWINGS

In the following, exemplary embodiments of the invention are described in more detail with respect to the enclosed figures:

FIG. 1 depicts a schematic view of an upper portion of an elevator system according to an exemplary embodiment of the invention.

FIG. 2A depicts an enlarged schematic front view of the upper portion of the hoistway adjacent to an upper end of the hoistway.

FIG. 2B depicts a schematic view from the top of the hoistway down into the hoistway.

FIG. 3 depicts a perspective view of an elevator machine support structure according to an exemplary embodiment of the invention supporting an elevator machine.

FIG. 4A depicts a first perspective view of the elevator machine support structure.

FIG. 4B depicts a second perspective view of the elevator machine support structure.

FIG. 5A depicts a perspective view of the first tension member dead end hitch according to an exemplary embodiment of the invention.

FIG. 5B depicts an explosive view of the tension member dead end hitch depicted in FIG. 5A.

FIG. 6A depicts a first perspective sectional view of the first tension member dead end hitch depicted in FIG. 5A.

FIG. 6B depicts a second perspective sectional view of the first tension member dead end hitch depicted in FIG. 5A.

### DETAILED DESCRIPTION OF THE INVENTION

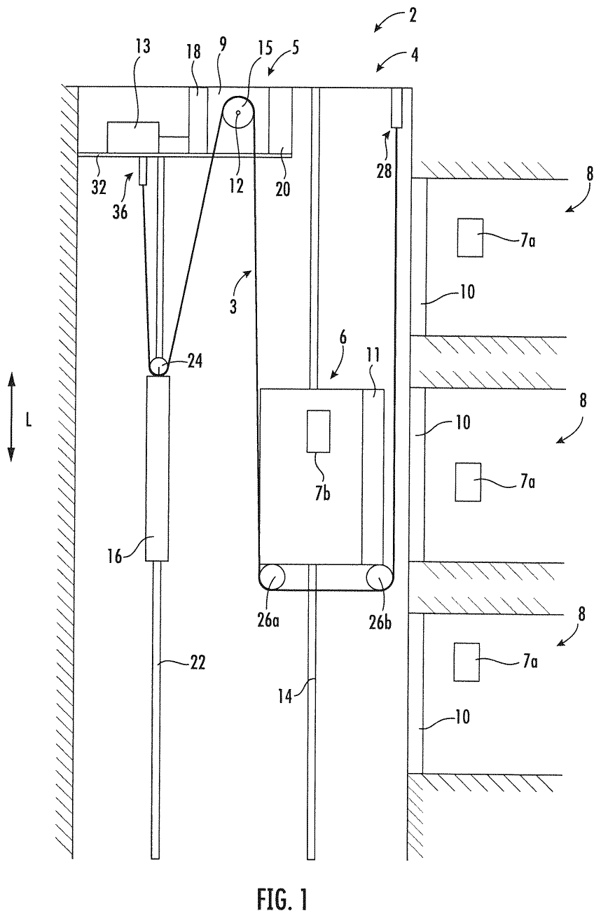

FIG. 1 depicts a schematic side view of an upper portion of an elevator system 2 according to an exemplary embodiment of the invention.

The elevator system 2 depicted in FIG. 1 comprises a hoistway 4 extending in a longitudinal direction L between a plurality of landings 8 located on different floors.

The elevator system 2 includes an elevator car 6 arranged in the hoistway 4 for being moved along the longitudinal direction L between the plurality of landings 8. The elevator car 6 may in particular be movable along at least one elevator car guide member 14, such as at least one elevator car guide rail, provided in the hoistway 4 and extending along the longitudinal direction L.

The longitudinal direction L may be oriented in a vertical direction, as it is depicted in FIG. 1. In an alternative embodiment, which is not depicted in the figures, the longitudinal direction L may be inclined with respect to the vertical direction.

Although only a single elevator car guide member 14 is visible in FIG. 1, the elevator system 2 may comprise a plurality of elevator car guide members 14 extending parallel to each other within the hoistway 4.

For simplicity of the illustration, only a single elevator car 6 is depicted in FIG. 1. Exemplary embodiments of the invention may, however, also include elevator systems 2 comprising a plurality of elevator cars 6 moving in one or more hoistways 4.

A landing door 10 is provided at each of the landings 8. The elevator car 6 is provided with a corresponding elevator car door 11 for allowing passengers to transfer between a landing 8 and the interior of the elevator car 6, when the elevator car 6 is positioned at the respective landing 8.

The elevator car 6 is movably suspended by means of at least one tension member 3.

The at least one tension member 3 may be a rope, e.g. a steel cord, or a belt, in particular a belt comprising a plurality of steel cords (not shown).

The at least one tension member 3 may be uncoated. Alternatively, the at least one tension member 3 may be coated with a coating, e.g. with a coating having the form of a polymer jacket. The at least one tension member 3 may in particular be a belt comprising a plurality of polymer coated steel cords. The elevator system 2 may comprise a plurality of tension members 3 extending parallel to each other.

The at least one tension member 3 is coupled to an elevator machine 5. The elevator machine 5 comprises a motor 9 for rotatably driving a shaft 12, and a drive 18 that harnesses and controls the supply of electrical energy to the motor 9. The elevator machine 5 is configured for driving the at least one tension member 3, which is coupled to the shaft 12, e.g. by a traction sheave 15, in order to move the elevator car 6 in the hoistway 4 along the longitudinal direction L between the plurality of landings 8.

The elevator machine 5 is provided with at least one elevator brake 20 for braking rotation of the shaft 12 and the traction sheave 15 mounted to the shaft 12 in order to allow for stopping movement of the elevator car 6.

The elevator system 2 further includes a counterweight 16. The counterweight 16 is also coupled to the at least one tension member 3 and configured for moving within the hoistway 4 along at least one counterweight guide member 22 concurrently and in opposite direction with respect to the elevator car 6.

In the exemplary embodiment of an elevator system 2 depicted in FIG. 1, a 2:1 roping is employed. The skilled person easily understands that different kinds of roping, such as a 4:1 roping, may be employed as well.

The movement of the elevator car 6 along the hoistway 4 between the different landings 8 is controlled by an elevator controller 13.

Input to the elevator controller 13 may be provided via an elevator car control panel 7b provided inside the elevator car 6, and/or via landing control panels 7a provided on every landing 8, in particular in the vicinity of the landing doors 10.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6 since the elevator system 2 is fully controlled by the commands input via the landing control panels 7a.

The landing control panels 7a and the elevator car control panel 7b may be coupled to the elevator controller 13 by means of electrical wiring not shown in FIG. 1, in particular by an electric bus, or by wireless data connections.

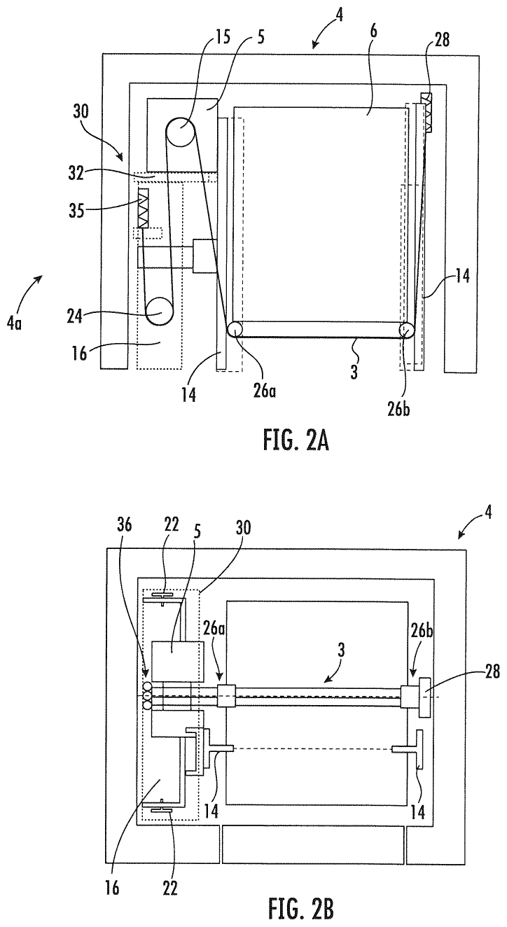

FIG. 2A depicts an enlarged schematic front view of the upper portion of the hoistway 4 adjacent to an upper end of the hoistway 4, and FIG. 2B depicts a schematic view from the top of the hoistway 4 down into the hoistway 4.

FIGS. 2A and 2B show that the elevator car 6 is guided by two elevator car guide member 14 extending on both sides of the elevator car 6. In further embodiments, which are not depicted in the figures, the elevator system 2 may comprise more than two guide members 14.

The counterweight 16 is guided by two counterweight guide members 22 extending along the longitudinal direction of the hoistway 4 as well.

As mentioned, in the exemplary embodiment of an elevator system 2 depicted in the figures, a 2:1 roping is employed.

The elevator system 2 comprises a plurality of tensions members 3 extending parallel to each other between a first tension member dead end hitch 36 located below the elevator machine 5 on the left side of the hoistway 4 in the FIGS. 2A and 2B, and a second tension member dead end hitch 28 located at the top of the hoistway 4 on the opposite side of the elevator car 6, which is the right side of the hoistway 4 in FIGS. 2A and 2B.

Three tensions members 3 are depicted in FIG. 2B. An elevator system 2 according to an exemplary embodiment of the invention may comprise more or fewer than three tension members 3. An elevator system 2 according to an exemplary embodiment of the invention may in particular comprise only a single tension member 3.

Each of the tension members 3 extends from the first tension member dead end hitch 36 down to a counterweight pulley 24 provided at the counterweight 16. The counterweight pulley 24 changes the direction of the tension members 3 so that the tension members 3 extend further upwards from the counterweight 16 to the traction sheave 15 of the elevator machine 5 located at the upper end of the hoistway 4.

The traction sheave 15 again changes the direction of the tension members 3, causing the tension members 3 to extend downwards again to first elevator car pulleys 26a that are mounted to the bottom of the elevator car 6.

Each tension member 3 is deflected by a corresponding first elevator car pulley 26a in order to extend basically horizontally below the bottom of the elevator car 6 to a second elevator car pulley 26b that is mounted to the bottom of the elevator car 6 on an opposite side of the elevator car 6.

The second elevator car pulleys 26b deflect the respective tension members 3 upwards towards the second tension member dead end hitch 28 provided at the upper end of the hoistway 4.

The elevator car 6 and the counterweight 16 may be moved concurrently and in opposite directions along the longitudinal extension of the hoistway 4 by rotating the shaft 12 and the traction sheave 15 mounted to the shaft 12.

The elevator machine 5 and the first tension member dead end hitch 36 are supported within the hoistway 4 by an elevator machine support structure 30.

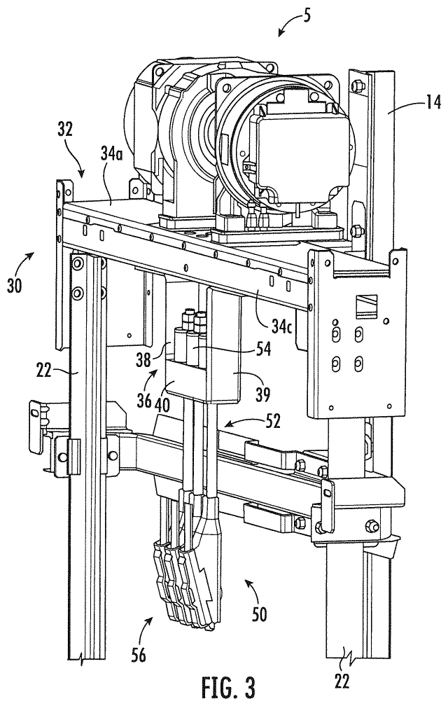

FIG. 3 shows a perspective view of an elevator machine support structure 30 according to an exemplary embodiment of the invention. The elevator machine support structure 30 is mounted to upper ends of the counterweight guide members 22 close to the top of the hoistway 4 and supporting the elevator machine 5.

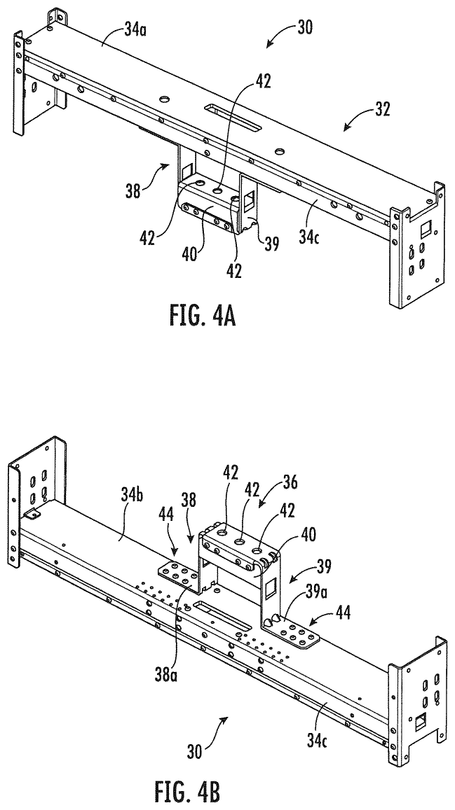

Perspective views of the elevator machine support structure 30 are depicted in FIGS. 4A and 4B.

The elevator machine support structure 30 comprises a machine bedplate 32 for supporting the elevator machine 5.

The machine bedplate 32 is provided as a hollow profile comprising an upper horizontal wall 34a and an opposing lower horizontal wall 34b extending parallel to each other. The hollow profile further comprises two vertical side walls 34c extending parallel to each other between the upper horizontal wall 34a and the lower horizontal wall 34b.

In an elevator system 2 according to an exemplary embodiment of the invention, the elevator machine 5 is arranged on the upper horizontal wall 34a, as it is depicted in FIG. 3.

The elevator machine support structure 30 further includes the first tension member dead end hitch 36. The first tension member dead end hitch 36 extends from the lower horizontal wall 34b of the machine bedplate 32 facing downwards.

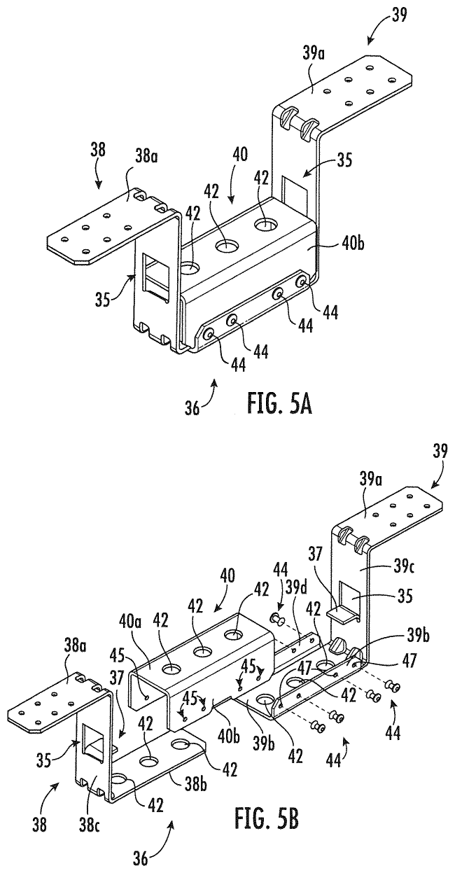

FIG. 5A depicts a perspective view of the first tension member dead end hitch 36 according to an exemplary embodiment of the invention, and FIG. 5B depicts an explosive view thereof.

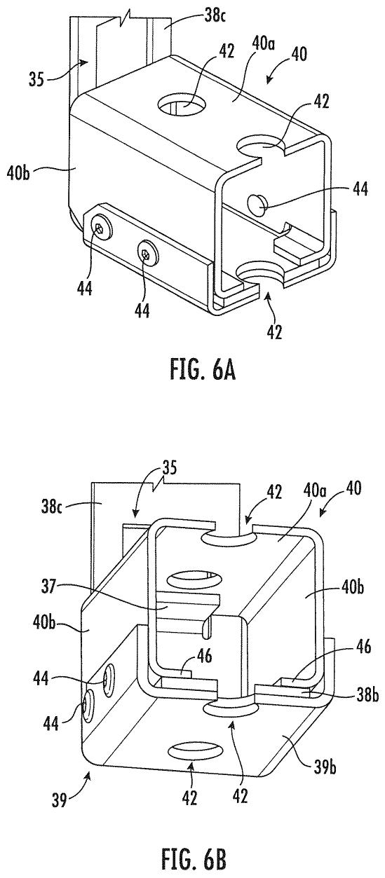

FIGS. 6A and 6B depict perspective sectional views of the first tension member dead end hitch 36 in the assembled state that is depicted in FIG. 5A.

The first tension member dead end hitch 36 comprises two legs 38, 39 and a hitch portion 40 that is arranged between the two legs 38, 39.

The two legs 38, 39 extend from the lower horizontal wall 34b of the machine bedplate 32. The hitch portion 40 extends generally horizontally between the two legs 38, 39 in some distance from the lower horizontal wall 34b of the machine bedplate 32. In consequence, an open space is formed between hitch portion 40 and the lower horizontal wall 34b of the machine bedplate 32 (see FIGS. 3, 4A and 4B).

Each of the two legs 38, 39 comprises an upper portion 38a, 39a, in particular a horizontal upper portion 38a, 39a, and a lower portion 38b, 39b, in particular a horizontal lower portion 38b, 39b, respectively.

Each of the first and second legs 38, 39 further comprises a vertical portion 38c, 39c extending between and generally perpendicularly to the horizontal upper and lower portions 38a, 39a, 38b, 39b of the respective leg 38, 39.

When the legs 38, 39 are mounted to the machine bedplate 32, as depicted in FIGS. 3, 4A and 4B, the horizontal upper portion 38a, 39a of each leg 38, 39 extends parallel to the machine bedplate 32 and is fixed to the lower horizontal wall 34b of the machine bedplate 32.

The horizontal lower portion 38b, 39b of each leg 38, 39 extends generally parallel to the horizontal upper portion 38a, 39a in an opposite direction from the respective vertical portion 38c, 39c of the respective leg 38, 39.

The second leg 39 further comprises two sidewalls 39d extending parallel to each other and perpendicularly from the horizontal lower portion 39b of the second leg 39. Several fixing openings 47 are formed in each of the two sidewalls 39d, respectively.

The hitch portion 40 is provided as a U-shaped profile comprising a horizontal upper side 40a and two vertical lateral sidewalls 40b extending parallel to each other basically perpendicularly from the horizontal upper side 40a. Several fixing openings 45 are formed in the two vertical lateral sidewalls 40b adjacent to the lower edges of the two vertical lateral sidewalls 40b.

For forming the first tension member dead end hitch 36, the horizontal lower portions 38b, 39b of the two leg 38, 39 are arranged in an overlapping configuration extending on top of each other, and the hitch portion 40 is arranged on top of the structure formed by the two overlapping lower portions 38b, 39b. The horizontal upper side 40a of the hitch portion 40 faces upwards, away from the horizontal lower portions 38b, 39b.

The hitch portion 40 is in particular arranged between the two sidewalls 39d formed at the horizontal lower portion 39b of the second leg 39.

For fixing the first and second legs 38, 39 and the hitch portion 40 to each other, several fixing elements 44, such as bolts, rivets or screws, extend through the fixing openings 45, 47 that are formed in the two vertical lateral sidewalls 40b of the hitch portion 40 and in the two sidewalls 39d of the second leg 39, respectively.

In an alternative configuration, which is not shown in the figures, the first and second legs 38, 39 and the hitch portion 40 may be soldered or welded to each other.

For enhancing the mechanical stability and rigidity of the first tension member dead end hitch 36, central portions of the lower edges of the sidewalls 40b of the hitch portion 40 may be folded inwards for forming horizontal latches 46 extending parallel to the horizontal lower portions 38b, 39b of legs 38, 39, as it is depicted in FIGS. 6A and 6B.

Further, a cutout 35 may be formed in the vertical portion 38c, 39c of each leg 38, 39, respectively. The part that has been cut out of the respective vertical portion 38c, 39c may be bent inwards for forming an additional latch 37 that supports the upper horizontal upper side 40a of the hitch portion 40, as it can be seen best in FIG. 6B. Providing such additional latches 37 may enhance the mechanical stability and rigidity of the first tension member dead end hitch 36 even further.

Several openings 42 are formed in the upper horizontal upper side 40a of the hitch portion 40 and in the horizontal lower portions 38b, 39b of the legs 38, 39, respectively. In the assembled configuration, the openings 42 formed in the upper horizontal upper side 40a of the hitch portion 40 and the openings 42 formed in the horizontal lower portions 38b, 39b of the legs 38, 39 are aligned with each other.

Referring again to FIG. 3, tension member termination devices 50 are employed for fixing the ends of the tension members 3 to the first tension member dead end hitch 36.

Each tension member termination device 50 comprises a rod portion 52 that extends through one of the openings 42 formed in the hitch portion 40, when the member termination device 50 is mounted to the first tension member dead end hitch 36, as it is depicted in FIG. 3.

Spring mechanisms 54 may be employed for coupling the tension member termination devices 50 to the first tension member dead end hitch 36 in order to allow for elastic movement of each of the tension member termination devices 50 and the elevator tension members 3 coupled thereto with respect to the first tension member dead end hitch 36.

Each of the tension member termination devices 50 further comprises a tension member fixing device 56, such as a wedge clamp, that is configured for receiving and fixing an end of a tension member 3.

The tension member termination devices 56 may in particular be configured for releasably coupling with the end of the tension member 3 in order to allow for conveniently replacing the tension members 3.

When an elevator machine support structure 30 according to exemplary embodiments of the invention is employed in an elevator system 2, the ends of the tension members 3 may be fixed to the elevator machine support structure 30 in positions below the elevator machine 5, i.e. in positions that are not offset from the position of the elevator machine 5 in a lateral direction, i.e. in a direction that is oriented perpendicularly to the longitudinal direction L of the hoistway 4.

In consequence, an elevator machine support structure 30 according to exemplary embodiments of the invention allows for arranging the first tension member dead end hitch 36 and the ends of the tension members 3 in a space saving configuration below the elevator machine 5, as it is depicted in FIG. 3.

In such a configuration, the elevator machine 5 does not interfere with the elevator car guide members 14, so that the elevator car guide members 14 do not need to be cut for providing space for the elevator machine 5.

In addition, the lateral distance between the tension members 3 and the elevator car 6 may be reduced. This allows for maximizing the size of the elevator car 6 in a given hoistway 4. It also allows for minimizing the footprint of the hoistway 4 for a given footprint of the elevator car 6.

Reducing the lateral distance between the tension members 3 and the elevator car guide members 14 may further allow for reducing noise and vibrations that are generated when the elevator system 2 is operated. This may allow for enhancing the ride quality for passengers traveling in the elevator car 6.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling in the scope of the dependent claims.

What is claimed is:

1. Elevator machine support structure (30) comprising:
a machine bedplate (32) for supporting an elevator machine (5) on a first side of the machine bedplate (32); and
a tension member dead end hitch (36) configured for mechanically coupling with an end of at least one elevator tension member (3);
wherein the tension member dead end hitch (36) extends from a second side of the machine bedplate (32) opposite to the first side.

2. Elevator machine support structure (30) according to claim 1, wherein the elevator machine support structure (30) is made of a sheet material, in particular of sheet metal, such as steel.

3. Elevator machine support structure (30) according to claim 1,
wherein the machine bedplate (32) comprises an upper horizontal wall (34a) and a lower horizontal wall (34b),
wherein the upper horizontal wall (34a) is configured for supporting the elevator machine (5) on an upper side thereof, and
wherein the tension member dead end hitch (36) is mounted to the lower horizontal wall (34b) such as to extend from a lower side of the lower horizontal wall (34b).

4. Elevator machine support structure (30) according to claim 1, wherein the tension member dead end hitch (36) comprises two legs (38, 39) extending from the second side of the machine bedplate (32) and a hitch portion (40) extending, particularly horizontally, between the two legs (38, 39) in a distance from the machine bedplate (32).

5. Elevator machine support structure (30) according to claim 4,
wherein each of the two legs (38, 39) comprises an upper portion (38a, 39a) that extends parallel to the machine bedplate (32) and that is fixed to the machine bedplate (32); and/or
wherein each of the two legs (38, 39) comprises a lower portion (38b, 39b) extending basically parallel to the machine bedplate (32), wherein the lower portions (38b, 39b) of the two legs (38, 39) are in particular mechanically coupled with each other.

6. Elevator machine support structure (30) according to claim 4, wherein the two legs (38, 39) and the hitch portion (40) of the tension member dead end hitch (36) are made of sheet metal.

7. Elevator machine support structure (30) according to claim 4, wherein the hitch portion (40) extends basically parallel to the machine bedplate (32); and/or wherein portions (38a-38c, 39a-39c) of the two legs (38, 39) extend basically parallel to each other, wherein portions (38b, 39b) of the two legs (38, 39) extend in particular perpendicularly to the machine bedplate (32).

8. Elevator machine support structure (30) according to claim 4, wherein the hitch portion (40) has a profile having a generally rectangular cross section.

9. Elevator machine support structure (30) according to claim 4,
wherein the elevator machine support structure (30) comprises fixing elements (44), such as bolts, rivets or screws, for fixing the two legs (38, 39) to the machine bedplate (32) and/or for fixing the hitch portion (40) to the two legs (38, 39); and/or
wherein the two legs (38, 39) are welded to the machine bedplate (32); and/or
wherein the hitch portion (40) is welded to the two legs (38, 39).

10. Elevator machine support structure (30) according to claim 4, wherein the hitch portion (40) is configured for mechanically coupling with a plurality of tension member termination devices (50) associated with the ends of a plurality of elevator tension members (3).

11. Elevator machine support structure (30) according to claim 1,
wherein the tension member dead end hitch (36) comprises at least one tension member termination device (50), including a tension member fixing device (56), in particular at least one wedge clamp;
wherein the tension member termination device (50) is supported by the tension member dead end hitch (36), particularly by the hitch portion (40), in a suspending manner.

12. Elevator system (2) comprising:
a hoistway (4) extending between a plurality of landings (8);
an elevator car (6) that is movable within the hoistway (4) between the plurality of landings (8);
an elevator machine support structure (30) according to claim 1;
an elevator machine (5) for moving the elevator car (6); and
at least one elevator tension member (3) mechanically coupling the elevator car (6) with the elevator machine (5) for allowing the elevator machine (5) to move the elevator car (6),
wherein the elevator machine (5) is supported on the machine bedplate (32) of the elevator machine support structure (30); and
wherein an end of the at least one elevator tension member (3) is coupled to the tension member dead end hitch (36) of the elevator machine support structure (30).

13. Elevator system (2) according to claim 12, wherein the at least one elevator tension member (3) is a belt and/or wherein the at least one elevator tension member (3) is coupled to the tension member dead end hitch (36) by a tension member termination device (50), in particular including a tension member fixing device (56), such as at least one wedge clamp.

14. Elevator system (2) according to claim 12, comprising a plurality of elevator tension members (3) extending parallel to each other.

15. Elevator system (2) according to claim 1,
wherein the elevator car (6) is coupled to the elevator machine (5) by the at least one elevator tension member (3) using a 2:1 roping, wherein the elevator car (6) is coupled to the elevator machine (5) in particular using an underslung 2:1 roping, in which a portion of the at least one elevator tension member (3) extends between elevator car pulleys (26a, 26b) mounted to a bottom of the elevator car (6); and/or
wherein the elevator system (2) further comprises a counterweight (16) that is coupled to the at least one elevator tension member (3), wherein the counterweight (16) comprises in particular at least one counterweight pulley (24) for mechanically coupling the counterweight (16) to the at least one elevator tension member (3).
